(19) United States
(12) Patent Application Publication
(10) Pub. No.: US 2022/0155076 A1
(43) Pub. Date: May 19, 2022

(54) METHOD, APPARATUS AND SYSTEM FOR NAVIGATING AUTONOMOUS VEHICLES

(71) Applicant: ZF Friedrichshafen AG, Friedrichshafen (DE)

(72) Inventors: Marc Abele, Radolfzell (DE); Mark Mohr, Tettnang (DE)

(21) Appl. No.: 17/438,472

(22) PCT Filed: Feb. 12, 2020
(86) PCT No.: PCT/EP2020/053512

§ 371 Date: Sep. 13, 2021

(30) Foreign Application Priority Data
Mar. 14, 2019 (DE) 10 2019 203 484.5

(51) Int. Cl. G01C 21/00; B60W 60/00; G05D 1/02

(52) U.S. Cl. CPC G01C 21/005; B60W 60/001; G05D 1/0234; G05D 2201/0205; B60W 2556/60; B60W 2554/00; B60W 2554/4041; G05D 1/0278

(57) ABSTRACT

A navigation method for an autonomous vehicle includes receiving sensor information from a sensor system attached to the autonomous vehicle, receiving object information from a management system that stores information regarding objects in a working area of the autonomous vehicle, and determining a position of the autonomous vehicle based on the sensor information and the object information.

### CROSS REFERENCE TO RELATED APPLICATIONS

This application is a U.S. National Phase application under 35 U.S.C. § 371 of International Application No. PCT/EP2020/053512, filed on Feb. 12, 2020, and claims benefit to German Patent Application No. DE 10 2019 203 484.5, filed on Mar. 14, 2019. The International Application was published in German on Sep. 17, 2020 as WO 2020/182391 A1 under PCT Article 21(2).

### FIELD

The present disclosure relates to a method for navigating autonomous vehicles using object information from a management system, and to an associated apparatus and to an associated method.

### BACKGROUND

In the operation of autonomous vehicles, in particular autonomous self-driving work machines and autonomous industrial trucks, a precise determination of the positioning of the vehicle must take place during the work, such as the transportation of goods, for example the receiving of a container in a container port, in order to be able to safely execute the receiving of the object, for example.

Due to the fields of application of the vehicles, however, instances often occur in which position determination via a global navigation satellite system can no longer take place with a precision that is sufficient for the intended purpose. This can result from shading by stacked containers, for example.

Alternative methods, such as odometry, also do not allow a sufficiently robust position determination to be implemented.

In the prior art (cf. DE 10 2016 108 446 A1), transponders are therefore integrated into the ground in the working areas of the vehicles, which transponders can then be used for position determination. However, such systems are complex and expensive to implement.

### SUMMARY

In an embodiment, the present disclosure provides a navigation method for an autonomous vehicle. The method includes receiving sensor information from a sensor system attached to the autonomous vehicle, receiving object information from a management system that stores information regarding objects in a working area of the autonomous vehicle, and determining a position of the autonomous vehicle based on the sensor information and the object information.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a flow chart with method steps of an exemplary embodiment of a method for navigating the autonomous vehicle;

FIG. 2 shows an example of a situation during navigation;

FIG. 3 shows a situation of detecting an object identification identifier;

FIG. 4 shows a situation of detecting information of an external measuring device; and

FIG. 5 shows a schematic representation of an apparatus and a system according to one embodiment.

### DETAILED DESCRIPTION

The present disclosure relates to a method, an apparatus, and a system which allows a robust and reliable position determination, or localization, of a vehicle even if a global navigation satellite system does not enable this in a current state.

First, a method for navigating an autonomous vehicle is disclosed.

Given an autonomous vehicle, this may in particular be an autonomous self-driving work machine. It may also be an autonomous industrial truck. The autonomous industrial truck, which can also be referred to as an autonomous floor conveyor, may be any manned or unmanned autonomous vehicle that is designed to transport goods and/or people and can be used in a logistics or industry environment.

Such an industrial truck can, for example, hereby be a container conveyor vehicle for transporting containers in a container port, such as a straddle loader, a container bridge, a reach stacker, a Mobiler, or a ContainerMover.

A navigation of the autonomous vehicle may hereby comprise establishing a current position as a location determination, ascertaining a route to the destination, and/or autonomously driving said route by autonomous vehicles. The navigation may also comprise controlling and/or regulating the autonomous vehicle or the driving dynamics of the vehicle in order to steer or control the autonomous vehicle to a destination.

The method first comprises receiving sensor information from a sensor system attached to the vehicle.

Such receiving may hereby be the receiving of a signal on the one hand, for example in the form of data packets. However, it may hereby also be the reading of such information from a memory. The transmission of information from one process to another in software may also be regarded as receiving.

The sensor system may be designed as a single sensor or comprise a plurality of sensors. Sensors may hereby be, for example, cameras, distance meters, LlDAR systems, laser-based sensors, radar-based sensors, ultrasound-based sensors, or the like. Accordingly, besides distance information, the sensor information may also include image information and similar information which is output by the aforementioned sensors. The received sensor information may generally be measured values or outputs of sensors of a vehicle.

The method then comprises receiving object information from a management system, which stores information regarding objects in a working area of the autonomous vehicle.

Such object information is generally to be understood as information which represents properties of the object. This may, for example, hereby be the dimension of an object, its position/localization, its surface structure, its color, or further properties characterizing the object.

A management system may, for example, hereby be a warehouse system, a management system, or an inventory system which stores such information about objects in a working area of a vehicle, such as a port area, a warehouse, or the like.

Such object information may be received in a processed or unprocessed manner. Receiving object information thus also hereby comprises intermediate processing on the part of the management system or on the part of the autonomously driving vehicle.

The working area is generally understood to mean an area in which the autonomous vehicle executes its activities, such as conveying or processing objects.

In the further step of the method, the position of the autonomous vehicle is determined on the basis of the sensor information and the object information.

Such a determination can, for example, be a comparison of the sensor information received from the sensor system with information obtained from the object information. A comparison of an actual value, obtained from the sensor information, with a target value obtained from the object information can thus be used for determination.

In other words, by comparing a state of the surroundings, and thus the sensor information, with present object information regarding objects, it can be determined where the vehicle is located in relation to the objects and thus in the working area.

For example, if the vehicle is thus located in an area in a container port in which strong shading is present as a result of containers stacked high, adjacent to which object in the working area the vehicle is located at what distance may thus be determined by means of the object information, which is obtained from the management system (e.g. from a warehouse system) in combination with sensor information. The absolute position of the vehicle can then be concluded from this relative information in relation to the objects.

The determination can thus hereby also comprise the determination of a relative position of the autonomous vehicle on the basis of the sensor information and the object information with respect to one or more objects in the working area of the vehicle, and the subsequent step of transforming this relative position into an absolute position.

The method may furthermore also comprise the step of switching from determining the position of the autonomous vehicle by means of a global navigation satellite system to determining the position of the autonomous vehicle on the basis of the sensor information and the object information, as described above.

Such a switching can hereby take place depending on the position determination precision by means of the global navigation satellite system, for example.

In particular, a switching can take place if the position determination precision by means of the global navigation satellite system falls below a threshold.

Accordingly, it can be checked whether the precision of the determination via the global satellite system satisfies a precision that is necessary for a specific work order. If this is not the case, switching to the determination by means of the sensor information and the object information can then take place.

This allows the navigation satellite system to be set during driving over a free area, but a relative navigation to be performed with the object information in relation to objects in the working area if shading that is too strong takes place.

For example, the number of satellites from which a signal is received can be used as parameters for determining the position determination precision of the global navigation satellite system; the elevation or a dilution-of-precision (DOP) value may likewise serve as a characteristic value.

It is also possible to implement such switching if a specific activity of the vehicle is performed. For example, if the vehicle performs an activity of driving over a free area, the global navigation satellite system can be used for position determination. However, if, for example, an activity of a work is performed on an object, such as the receiving/loading of the object, the relative position determination by means of the object information can be resorted to in order to enable an optimally accurate positioning with respect to the object on which the work is performed.

In the step of determining the position of the autonomous vehicle on the basis of the sensor information and the object information, the method may furthermore access external distance information. Such external distance information is information which is measured by an external measuring device. This distance information measured by a measuring device external to the autonomous vehicle can hereby in particular be detected with the sensor system.

Such a measuring device may, for example, be a distance measuring device that is attached to an object which, for example, indicates via a display a distance of the vehicle from the measuring device.

This display may, for example, be detected, i.e., read, with a camera of the sensor system of the vehicle and then processed.

This allows the simple integration of autonomous vehicles into operations that operate with both autonomous and non-autonomous vehicles, since the same information regarding the distance from an object, such as from a loading position of a container crane, can be used for navigation both by the autonomous vehicle and by the driver of a non-autonomous vehicle.

In order to further improve the positioning of the vehicle in space, the method may furthermore provide that an object information identification is recorded by the sensor system of the vehicle. Such an object identification identifier may be, for example, a barcode, a QR code, or the like which is attached to an object. The sensor used by the sensor system may hereby in particular be a camera. By means of this recorded object identification identifier, object information associated with the object can then be queried from the management system. This information can then be used in the step of determining the position of the autonomous vehicle (relative to this object).

This makes it possible to further improve the positioning, since specific information, such as a dimension of an object such as a container, can be queried for an object located in the environment of the vehicle. In addition, a rough positioning of the vehicle can already be determined by what object identification identifiers of which objects are situated in the detection range of the sensors.

The position of the vehicle can then be robustly determined on the basis of the information recorded by the sensor system and the object information regarding the object bearing the object information identification. For example, on the basis of the retrieved information regarding a dimension of the object and on the basis of camera data or data of a distance measuring system, it may thus be determined at what distance and in which orientation relative to the object the autonomously driving vehicle is located.

In addition, the positioning in the working area of the machine can also be retrieved from the management system as object information, which enables a conversion of the relative position of the vehicle to an absolute position.

Furthermore, in a further step, environmental information such as map information in two-dimensional or three-dimensional form can be derived from the object information in a management system.

In other words, environmental information or mapping can be derived on the basis of the information regarding the objects that is stored in the management system, such as absolute position, dimension, position in a stack of objects etc. This can even take place in three-dimensional form, since the extent of the objects in three-dimensional space can be calculated or derived via the information regarding heights of objects and their arrangement one above the other.

The result is thus a two-dimensional or a three-dimensional mapping as environmental information resulting from the information stored in the management system.

This environmental information thus obtained can be used as object information in the step of determining the position of the autonomous vehicle.

The calculation of the environmental information can hereby on the one hand take place in the vehicle itself, but also in an external system such as the management system or a unit connected thereto.

Accordingly, on the one hand, the method can comprise the step of determining environmental information from object information in the management system, wherein this step is executed in the external unit.

Alternatively, the method may comprise the step of calculating the environmental information from the information received from the management system, wherein this step is executed in the vehicle and the environmental information is used as object information in the determining step.

The present disclosure additionally relates to an apparatus for navigating an autonomous vehicle which is configured to execute the method.

The disclosure further relates to an apparatus for navigating an autonomous vehicle, comprising a sensor system, a sensor information receiving means, and a position determination means.

The means are designed in accordance with the method described above.

This system may furthermore have respective means for executing the further method steps mentioned above.

A corresponding system for navigating an autonomous vehicle firstly comprises a sensor system attached to a vehicle, comprising at least one sensor. For the definition of the sensors, reference is made to the above statements regarding the method.

A sensor information receiving means is then configured to receive this information from this sensor system.

A management system is furthermore comprised in the system and stores object information regarding objects in a working area of the autonomous vehicle.

The system furthermore comprises an object information receiving means for receiving object information from the management system.

The system also has calculation means which are configured to calculate environmental information from the object information received by the object information receiving means, wherein the object information includes information about the dimension and positions of objects in a working area of the autonomous vehicle.

Regarding calculating the environmental information from the object information, reference is made to the above statements regarding the corresponding method step.

The system furthermore comprises a position determination means which is designed to determine the position of the autonomous vehicle on the basis of the sensor information and environmental information output as object information by the calculation unit.

According to the above statements regarding the method, the system may furthermore be designed in such a way that the position determination means is configured to switch, depending on the position determination precision on the one hand and the activity performed by the autonomous vehicle on the other hand, from determining the position of the autonomous vehicle by means of a global navigation satellite system to determining the position of the autonomous vehicle on the basis of the sensor information and the object information.

For this purpose, a further receiving means for global navigation satellite systems may be provided which receives and processes data from one or more global navigation satellite systems.

A means may hereby also be designed as software, a software module, or the like, and is not limited to the embodiment as a physical unit.

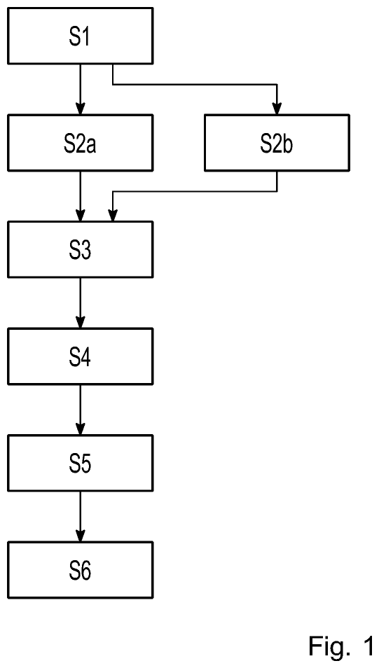

Shown in FIG. 1 are method steps of the method for navigating an autonomous vehicle in a sequence.

In a first step S1, the vehicle firstly navigates by means of a global satellite navigation system.

The vehicle hereby drives over a free area in a container port, for example.

If the vehicle approaches an object, here a container, the system checks, in step S2a or in step S2b, whether the position determination precision by means of the global navigation system falls below a threshold value (S2a), or whether the vehicle approaches a container to be received, so that the performed activity of the autonomous vehicle changes (S2b) to approaching an object to be received and, if one of the instances occurs, in step S3 switches to a mode in which the position determination no longer takes place via the global navigation satellite system but rather by means of sensor information and object information.

In order to execute this navigation, the system then receives sensor information from a sensor system of the vehicle in step S4.

In step S5, information regarding objects in the surroundings of the vehicle is also received via an interface to a management system, here a wireless transmission from a logistics system.

The autonomous vehicle thus receives information about the positions and dimensions of containers in its surroundings.

In step S6, the autonomous vehicle can then determine, on the basis of the information about the dimensions and the positions of the containers in the surroundings, as well as via the items of environmental information of the vehicle which are detected by the sensors of the vehicle, where the vehicle is located relative to the objects.

From this relative information, an absolute position of the vehicle can then be calculated in the same step, so that the exact position of the vehicle can be determined even without the use of navigation satellites, with greater robustness and only with information from an already existing warehouse system.

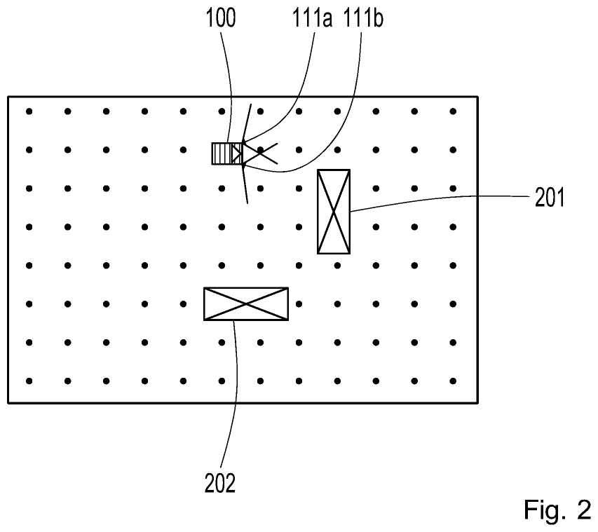

As shown in FIG. 2 in an exemplary situation, the autonomous vehicle 100 can detect the containers 201 and 202 by means of the sensors 111a and 111b. With the aid of object information about the dimension of the containers 202 and the absolute position of the containers, the vehicle 100 can then determine its position in both a relative and an absolute manner.

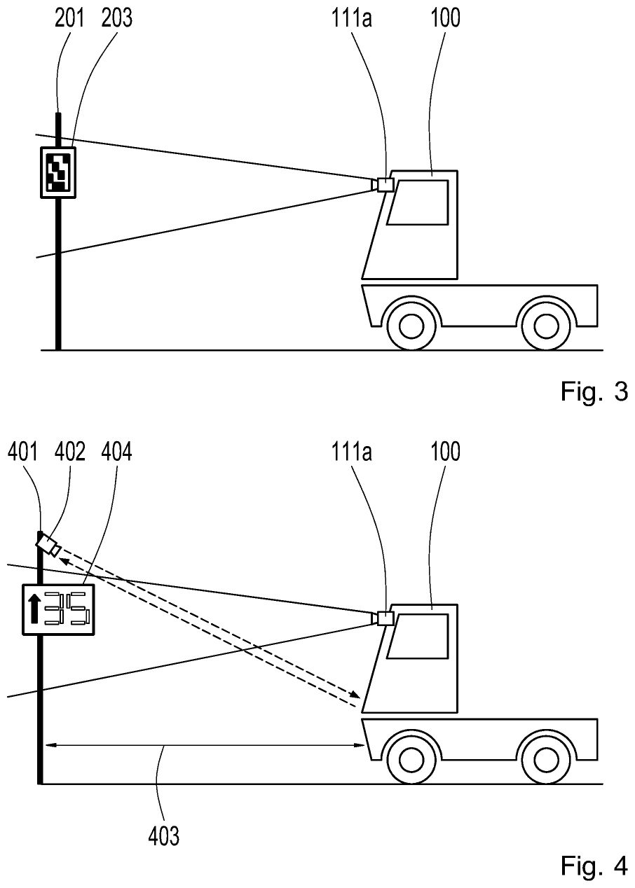

Shown in FIG. 3 is the detection of the object identification identifier 203 of a container 201 as another exemplary situation. The vehicle 100 with the sensor 111a approaches the container 201. Affixed thereto is the QR code 203. This is recognized or recorded by the sensor 111a, which here is designed as a camera. By means of this information, the vehicle 100 can then query the management system (not shown here) for information regarding the container 201, such as its dimension. This information might then be used in the calculation described above for determining the position of the vehicle.

Furthermore shown in FIG. 4, by way of example, is the situation in which an external measuring device is used.

The vehicle 100 with the sensor 111a, designed here as a camera, approaches the object 401, here a container bridge. This container bridge has an external measuring device 402 which measures the distance 403 from the vehicle 100. The measurement result is output on the display 404 of the measuring device 402. By means of the camera 111, the vehicle 100 records the measuring result of the external measuring device 402 in that the distance displayed on the display 404 of the measuring device 402 is detected and further processed by means of image processing. This distance thus ascertained can then be used for position determination, as described above.

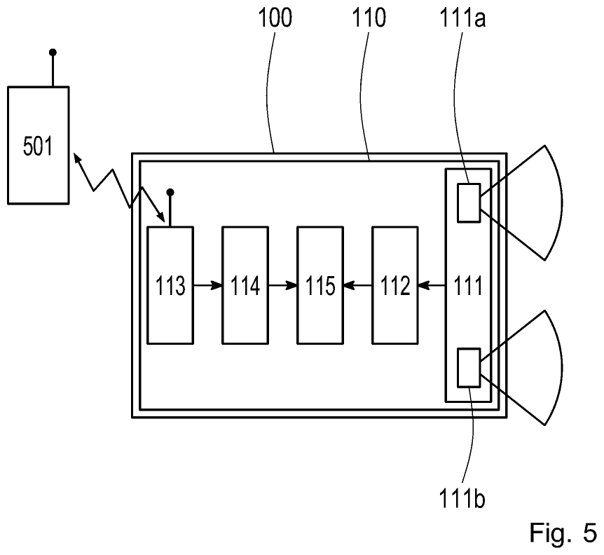

FIG. 5 shows an apparatus and an associated system for navigating a vehicle according to an exemplary embodiment. The apparatus 110 of the vehicle 100 hereby comprises a sensor system 111 with a plurality of sensors 111a and 111b which record objects in respective detection ranges. The output of this sensor system is forwarded to the sensor information receiving means 112. The apparatus furthermore comprises an object information receiving means 113 which receives the object information from a management system 501 of the system. The system furthermore comprises a calculation means 114 which, in the shown exemplary embodiment, is arranged in the apparatus 110. As described above, this calculation means is configured to determine environmental information from the object information received by means of the object information receiving means 113. The output of the calculation means 114 and of the sensor information receiving means 112 is then supplied to the position determination means 115, which can determine the position of the vehicle 100 on the basis of this information.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE CHARACTERS

S1 Navigating by means of a global navigation satellite system
S2a Checking the position determination precision
S2b Checking the performed activity
S3 Switching the position determination
S4 Receiving sensor information
S5 Receiving object information
S6 Determining the position
100 Autonomous vehicle
110 Apparatus
111 Sensor system
111a Sensor
111b Sensor
112 Sensor information receiving means
113 Object information receiving means
114 Calculation means
115 Position determination means
201, 202 Container
203 Object identification identifier
401 Container bridge
402 External measuring device
403 Distance
404 Display of the measuring device
501 Management system

1. A navigation method for an autonomous vehicle, the method comprising:
receiving sensor information from a sensor system attached to the autonomous vehicle;
receiving object information from a management system which that stores information regarding objects in a working area of the autonomous vehicle; and
determining a position of the autonomous vehicle based on the sensor information and the object information.

2. The method according to claim 1, further comprising:
determining that a precision of determining a position of the autonomous vehicle via a global navigation satellite system falls below a threshold value; and
in response to the determining that the precision falls below the threshold value, switching from determining the position of the autonomous vehicle via the global navigation satellite system to determining the position of the autonomous vehicle based on the sensor information and the object information.

3. The method according to claim 1, further comprising:
switching, depending on activity performed by the autonomous vehicle, from determining the position of the autonomous vehicle via a global navigation satellite system to determining the position of the autonomous vehicle based on the sensor information and the object information.

4. The method according to claim 1, wherein:
determining the position of the autonomous vehicle based on the sensor information and the object information further comprises determining the position based on distance information received from an external measuring device via a sensor of the sensor system.

5. The method according to claim 1, further comprising:
receiving, by a sensor of the sensor system, an object identification identifier attached to an object in an environment of the vehicle; and
querying the management system for object information regarding the object to which the object identification identifier is attached,
wherein the determining the position of the autonomous vehicle based on the sensor information and the object information uses the queried object information regarding the object to which the object identification identifier is attached.

6. The method according to claim 1, further comprising:
calculating environmental information from object information in the management system, wherein the object information includes information about dimensions and positions of objects; and
outputting the environmental information as object information to the autonomous vehicle.

7. The method according to claim 1, further comprising:
calculating environmental information from object information received from the management system, wherein the object information includes information about dimensions and positions of objects, wherein
the determining the position of the autonomous vehicle based on the sensor information and the object information uses the environmental information as object information.

8. A navigation apparatus for an autonomous vehicle, comprising:
a sensor system attached to the autonomous vehicle, the sensor system including at least one sensor;
a sensor information receiver configured to receive sensor information from the sensor system;
an object information receiver configured to receive object information from a management system that stores information regarding objects in a working area of the autonomous vehicle; and
processing circuitry configured to process the position of the autonomous vehicle based on the sensor information and the object information.

9. A navigation apparatus for an autonomous vehicle, comprising:
a sensor system attached to the autonomous vehicle, the sensor system including at least one sensor;
a sensor information receiver configured to receive sensor information from the sensor system;
a management system configured to store object information regarding objects in a working area of the autonomous vehicle;
an object information receiver configured to receive object information from the management system;
a calculator configured to calculate environmental information from the object information received by the object information receiver, wherein the object information includes information about dimensions and positions of objects in a working area of the autonomous vehicle, and
processing circuitry configured to determine the position of the autonomous vehicle based on the sensor information and environmental information output as object information by the calculator.

10. The apparatus according to claim 9, wherein the processing circuitry is further configured to determine that a precision of determining a position of the autonomous vehicle via a global navigation satellite system falls below a threshold value, and in response to the determining that the precision falls below the threshold value, switch from determining the position of the autonomous vehicle via a global navigation satellite system to determining the position of the autonomous vehicle based on the sensor information and the object information.

11. The apparatus for navigating an autonomous vehicle according to claim 9, wherein the processing circuitry is further configured to switch, depending on the activity performed by the autonomous vehicle, from determining the position of the autonomous vehicle via a global navigation satellite system to determining the position of the autonomous vehicle based on the sensor information and the object information.
